(19) United States
(12) Patent Application Publication
(10) Pub. No.: US 2018/0293963 A1
(43) Pub. Date: Oct. 11, 2018

(54) DISPLAY APPARATUS AND CONTROLLING METHOD THEREOF

(71) Applicant: SAMSUNG ELECTRONICS CO., LTD., Suwon-si (KR)

(72) Inventors: Myung-sik KIM, Suwon-si (KR); Yeong-rok LEE, Suwon-si (KR); Mi-young KIM, Suwon-si (KR); Tae-gyu LIM, Gwacheon-si (KR)

(73) Assignee: SAMSUNG ELECTRONICS CO., LTD., Suwon-si (KR)

(21) Appl. No.: 15/945,815

(22) Filed: Apr. 5, 2018

(30) Foreign Application Priority Data
Apr. 7, 2017 (KR) 10-2017-0045319

(51) Int. Cl. G09G 5/38; G05D 1/00; G09G 5/391; H04N 1/00; G06F 3/0488; G06F 3/041

(52) U.S. Cl. CPC G09G 5/38; G05D 1/00; G09G 5/391; G06F 2203/04803; G06F 3/0488; G06F 3/0412; H04N 1/00411

(57) ABSTRACT

A display apparatus is provided. The display apparatus includes a display panel configured to display a content, a view field divider provided at a front side of the display panel and configured to divide a view field in which the content is provided, a sensor configured to sense a user, and a processor configured to identify an area which is viewable by the sensed user between a first area which is viewable by a user at a first direction and a second area which is viewable by a user at a second direction based on the display apparatus, and control the view field divider to provide the content to the identified area.

### CROSS-REFERENCE TO RELATED APPLICATIONS

This application is based on and claims priority from Korean Patent Application No. 10-2017-0045319, filed on Apr. 7, 2017 in the Korean Intellectual Property Office, the disclosure of which is incorporated herein by reference in its entirety.

### BACKGROUND

### Field

Aspects of the embodiments relate to a display apparatus and a controlling method thereof, and more specifically, to a display apparatus which provides different content views according to a viewing position, and a controlling method thereof.

### Description of Related Art

Recently, the existing mechanical systems composing a vehicle have been rapidly being replaced by electrical and electronic systems. For instance, a display apparatus is vitally mounted on a dashboard of a vehicle for various purposes such as a navigation using a Global Positioning System (GPS), front and rear cameras, vehicle control, Digital Multimedia Broadcasting (DMB), and the like.

The display apparatus for the vehicle is connected to an external user terminal apparatus, and allows the driver to check external connections while driving. However, there has been a problem that when the displays apparatus for a vehicle displays the content which was received via the external user terminal apparatus, the driver's personal call, Short Message Service (SMS) and the like are also exposed to a fellow passenger.

In addition, there has been a problem that if a content that interferes the driver's driving, for example, a video content, is not displayed while driving, the fellow passenger also could not receive the video content.

Accordingly, there is a need for a display apparatus which displays information required for driving a vehicle or a personal content for a driver, and displays different contents for a fellow passenger, at the same time in one display.

### SUMMARY

Embodiments of the present disclosure has been made to solve the above problems. According to an embodiment, there is provided a display apparatus comprising: a display panel configured to display a content; a view field divider provided at a front side of the display panel, wherein the view field divider divides a view field in which the content is provided; a sensor configured to sense a location of a user; and a processor configured to identify an area between a first area viewable at a first direction from the display apparatus and a second area viewable at a second direction from the display apparatus based on the sensed location of the user, and control the view field divider to provide the content to the identified area.

The sensor maybe further configured to sense a first location of a first user and a second location of a second user; and the processor maybe further configured to: identify, based on the sensed first and second locations of the first and second users, respectively, that the first user is positioned at the first direction and the second user is positioned the second direction; and provide different contents or the same content to the first area and the second area based on a predetermined standard.

The predetermined standard maybe a privacy level for each content, and wherein the processor maybe further configured to provide a first content having a first privacy level equal to or higher than a predetermined level to one of the first area and the second area, and provide a second content having a second privacy level lower than the predetermined level to both of the first area and the second area.

The processor, in response to providing the first content to the one of the first area and the second area, maybe further configured to provide the second content to a remaining one of the first area and the second area.

The processor maybe further configured to provide the different contents with different resolutions.

The display apparatus may further comprise: a communication interface configured to communicate with at least one external terminal apparatus, wherein the content may include an application executed in the external terminal apparatus.

The processor maybe further configured to provide, in response to a privacy level of the application being equal to or higher than a predetermined level, the application to an area which is viewable by a user of the external terminal apparatus between the first area and the second area.

The display apparatus maybe implemented as a display apparatus for a vehicle, wherein the first direction maybe a driver direction from the display apparatus for a vehicle, and wherein the second direction maybe a passenger seat direction from the display apparatus for a vehicle.

The sensor maybe further configured to sense a touch direction with regard to the display panel, and wherein the processor maybe further configured to execute, in response to a touch command being input on the display panel, a function corresponding to the touch command on a content provided to an area corresponding to a touch direction of the touch command between the first area and the second area.

The display apparatus maybe implemented as a display apparatus for a vehicle, wherein the sensor is further configured to sense a touch direction with regard to the display panel, and wherein the processor maybe further configured to execute, in response to a touch command with regard to a vehicle control menu provided on the display panel being input, a vehicle control function with regard to an area corresponding to a touch direction of the touch command between the first area and the second area.

According to an embodiment, there is provided a controlling method of a display apparatus which comprises a display panel and a view field divider provided at a front side of the display panel and configured to divide a view field in which a content is provided, the controlling method comprising: sensing a location of a user; identifying, based on the sensed location of the user, an area between a first area viewable at a first direction from the display apparatus and a second area viewable at a second direction from the display apparatus, and providing the content to the identified area by controlling the view field divider.

The controlling method may further comprise: sensing a first location of a first user and a second location of a second user; and identifying, based on the sensed first and second locations of the first and second users, respectively, that the first user is positioned at the first direction and the second user is positioned the second direction; and providing different contents or the same content to the first area and the second area based on a predetermined standard.

The predetermined standard maybe a privacy level for each content, and wherein the providing the content may further comprise: providing a first content having a first privacy level equal to or higher than a predetermined level to one of the first area and the second area, and providing a second content having a second privacy level lower than the predetermined level to both of the first area and the second area.

The providing the content may further comprise, in response to providing the first content to the one of the first area and the second area, providing the second content to a remaining area one of the first area and the second area.

The providing the content may further comprise providing the different contents with different resolutions.

The controlling method may further comprise communicating with at least one external terminal apparatus, wherein the content includes an application executed in the external terminal apparatus.

The providing the content may further comprise, in response to a privacy level of the application being equal to or higher than a predetermined level, providing the application to an area which is viewable by a user of the external terminal apparatus between the first area and the second area.

The display apparatus may be implemented as a display apparatus for a vehicle, wherein the first direction maybe a driver direction from the display apparatus for a vehicle, and wherein the second direction maybe a passenger seat direction from the display apparatus for a vehicle.

The sensing may further comprise sensing a touch direction with regard to the display panel, and wherein the controlling method may further comprise, in response to a touch command being input on the display panel, controlling to execute a function corresponding to the touch command on a content provided to an area corresponding to a touch direction of the touch command between the first area and the second area.

The display apparatus maybe implemented as a display apparatus for a vehicle, wherein the sensing may further comprise sensing a touch direction with regard to the display panel, and wherein the controlling method may further comprise, in response to a touch command with regard to a vehicle control menu provided on the display panel being input, controlling to execute a vehicle control function with regard to an area corresponding to a touch direction of the touch command between the first area and the second area. According to various embodiments, the display apparatus provides a content to the area which is viewable by a user and provides the content of which privacy level is equal to or higher than a predetermined level to one area, and thus, an invasion of privacy may be prevented when using the display apparatus.

### BRIEF DESCRIPTION OF THE DRAWINGS

FIG. 1 is a view illustrating an operation of a display apparatus for better understanding of an embodiment;

FIG. 2 is a block diagram illustrating a configuration of a display apparatus according to an embodiment;

FIGS. 3A and 3B are views illustrating a composition of a display according to an embodiment;

FIGS. 4A and 4B are views illustrating a method for displaying a content based on a privacy level according to an embodiment;

FIG. 5 is a view illustrating a method for displaying a content based on a content type according to an embodiment;

FIG. 6 is a view illustrating a controlling method of a display apparatus based on a touch direction according to an embodiment;

FIG. 7 is a view illustrating an embodiment in which a display apparatus is implemented as a display apparatus for a vehicle according to an embodiment;

FIG. 8 is a view illustrating an embodiment in which a display apparatus is connected to a vehicle according to another embodiment; and

FIG. 9 is a flow chart illustrating a method for controlling a display apparatus according to an embodiment.

### DETAILED DESCRIPTION

Hereinafter, embodiments will be described in more detail with reference to the accompanying drawings. Also, well-known functions or constructions are not described in detail since they would obscure the disclosure with unnecessary detail. In addition, the embodiments may be changed in various forms, and therefore, the technical scope is not limited to the following embodiments. Rather, these embodiments are provided to make the present disclosure thorough and complete.

Unless explicitly described otherwise, the term ‘including’ will be understood to imply the inclusion of a component, but not the exclusion of any other components. Further, various elements and areas in the drawings are schematically drawn. Therefore, the technical ideas are not limited by a relative size or interval drawn in the accompanying drawings.

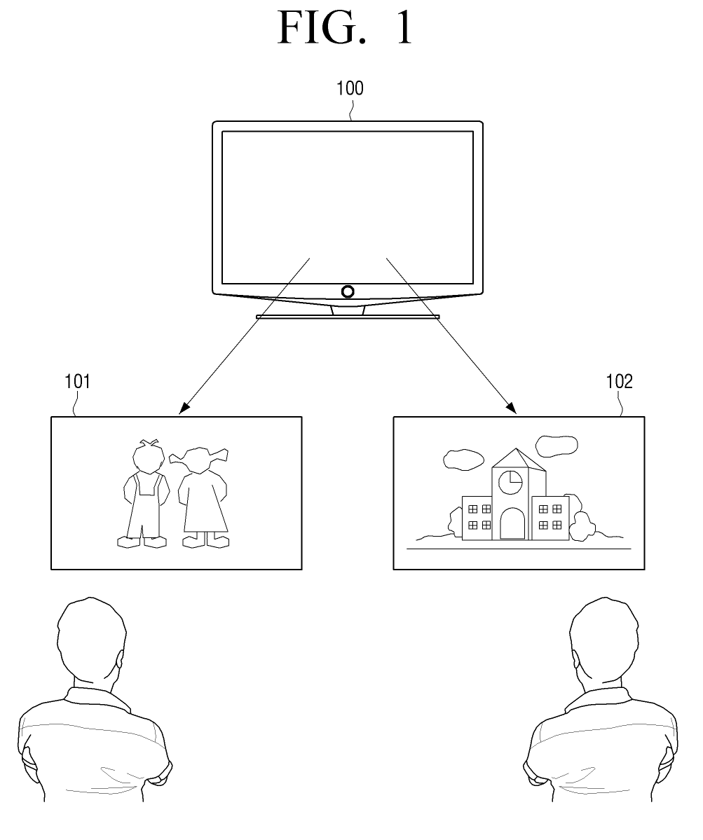

FIG. 1 is a view illustrating an operation of a display apparatus 100 for better understanding of an embodiment.

According to FIG. 1, the display apparatus 100 according to an embodiment may divide a view field and provide a plurality of contents to different areas at the same time. Specifically, the display apparatus 100 may divide the view field which is spaced apart from the display apparatus 100 for a certain distance into a first area 101 which is viewable by a user at a first direction based on the display apparatus 100 and a second area 102 which is viewable by a user at a second direction based on the display apparatus 100, and provide different contents to the first area 101 and the second area 102.

For example, as illustrated in FIG. 1, the display apparatus 100 may divide the view field spaced apart for a certain distance into the left area viewable by the user at the left side and the right area viewable by the user at the right side, and provide different contents to the left area and the right area at the same time. In this case, the user at the left side of the display apparatus 100 may view the content provided to the left side, and the user at the right side of the display apparatus 100 may view the content provided to the right side.

Meanwhile, it is not limited thereto, and the display apparatus 100 may divide the view field spaced apart for a certain distance from the display apparatus 100 into at least three areas and provide contents to each area. For example, the display apparatus 100 may divide the view field into the areas which is viewable by a user at the left, right, and middle side of the display apparatus 100, and provide different contents to each area.

In addition, the display apparatus 100 according to an embodiment may sense a user, determine the area which is viewable by the sensed user, and provide a content to the determined area. For example, if it is determined that the user is sensed at the first direction and the area viewable by the user at the first direction is the first area 101, the display apparatus 100 may provide a content to the first area 101. In this case, the display apparatus 100 may not provide a content to the second area 102.

As illustrated in FIG. 1, if users are sensed at each of the first direction and the second direction, the display apparatus 100 may provide contents to both of the first area 101 and the second area 102. In this case, the display apparatus 100 may provide different contents or the same content to the first area 101 and the second area 102 based on the predetermined standard. Here, the predetermined standard may be one of a privacy level of the content and a type of a content.

For example, if the predetermined standard is the privacy level of a content, the content having a privacy level equal to or higher than a predetermined level, among a plurality of contents which is being displayed by the display apparatus 100, may be provided to one of the first area 101 and the second area 102. In this case, different contents may be provided to the first area 101, which is viewable by the user at the first direction and the second area 102, which is viewable by the user at the second direction.

Here, the privacy level is the value set for each content. Specifically, the privacy level may be at least one of a level set by a user for each content and a predetermined level for each content. In addition, the privacy level may be set for each category of a content and for a specific content. For example, the privacy level of all contents of which category is photo may be set to be equal to or higher than the predetermined level, or the privacy level of only a specific photo among the photo contents may be set to be equal to or higher than the predetermined level.

Accordingly, the display apparatus 100 may provide the content of which privacy level is equal to or higher than a predetermined level to one of the first area 101 viewable by the user at the first direction and the second area 102 viewable by the user at the second direction. For example, as illustrated in FIG. 1, the display apparatus 100 may provide a personal video content having a privacy level equal to or higher than a predetermined level only to the first area 101, which is viewable by the user at the first direction. In this case, not the personal video content, but another content may be provided to the user at the second direction.

In addition, while the first content having a privacy level lower than the predetermined level is provided to the first area 101 and the second area 102, if the second content having privacy level having equal to or higher than the predetermined level is additionally provided, the display apparatus 100 may provide the second content to one of the first area 101 and the second area 102. In this case, the display apparatus 100 may not provide the second content to a remaining area, and provide the first content continuously.

Hereinafter, the content having a privacy level equal to or higher than the predetermined level would be called a personal content, and the content having a privacy level lower than a predetermined level would be called a public content, for convenience in explanation.

Hereinafter a detailed configuration of the display apparatus 100 will be explained.

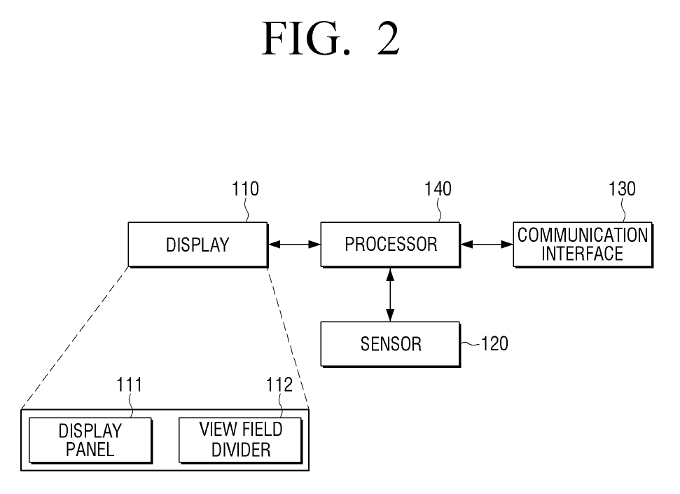

FIG. 2 is a block diagram illustrating a configuration of a display apparatus 100 according to an embodiment.

According to FIG. 2, the display apparatus 100 may include a display 110, a sensor 120, a communication interface 130 and a processor 140.

The display apparatus 100 may be implemented as various types of apparatuses such as a TV, a monitor, a personal computer (PC), a tablet PC, a display apparatus for a vehicle, a navigation and the like.

The display 110 may include a display panel 111 which displays a plurality of contents at the same time, and a view field divider 112 which divides a view field in which contents are provided into a plurality of areas.

Specifically, the display panel 111 may include a plurality of pixels having a plurality of sub pixels. Here, the sub pixels may consist of Red (R), Green (G), and Blue (B). Thus, the display panel 111 may be configured by arranging the pixels consisting of R, G, B sub pixels toward a plurality of lines and columns. In this case, the display panel 111 may be implemented as various display units such as a liquid crystal display (LCD) panel, a plasma display panel (PDP), an organic light emitting diode (OLED), a vacuum fluorescent display (VFD), a field emission display (FED), and an electro luminescence display (ELD).

Although not illustrated in FIG. 2, if the display panel 111 is implemented as the LCD panel, the display apparatus 100 may further include a panel driver (not illustrated) which drives pixels of the display panel 111 according to the pixel value of each pixel which constitutes a backlight unit (not illustrated), which supplies a backlight to the display panel 111, and an image frame.

The view field divider 112 may be disposed at the front side of the display panel 111 and divide the view field spaced apart for a certain distance from the display apparatus 100 into a plurality of virtual areas. Here, the view field refers to the area in which a content is provided to a user positioned at each direction. Specifically, a plurality of contents displayed on the display panel 111 may be divided by the view field divider 112 and provided to each area. For example, the view field divider 112 may divide the view field into the first area 101 and the second area 102, and the user at the first direction from the display apparatus 100 may view the content provided to the first area 101, and the user at the second direction from the display apparatus 100 may view the content provided to the second area 102.

Meanwhile, the view field divider 112 may be implemented as a lenticular lens or a parallax barrier.

For example, if the view field divider 112 is implemented as the parallax barrier, the parallax barrier may include a transparent slit array which includes a plurality of barrier areas. Thereby, by blocking light with the slit between the barrier areas, the view field divider 112 may cause different contents to be provided to the first area 101 and the second area 102, respectively.

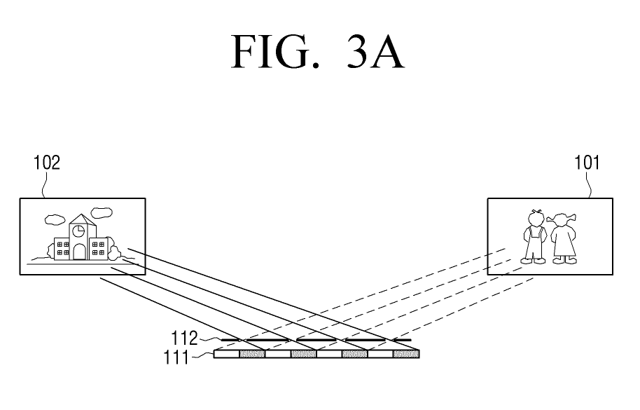

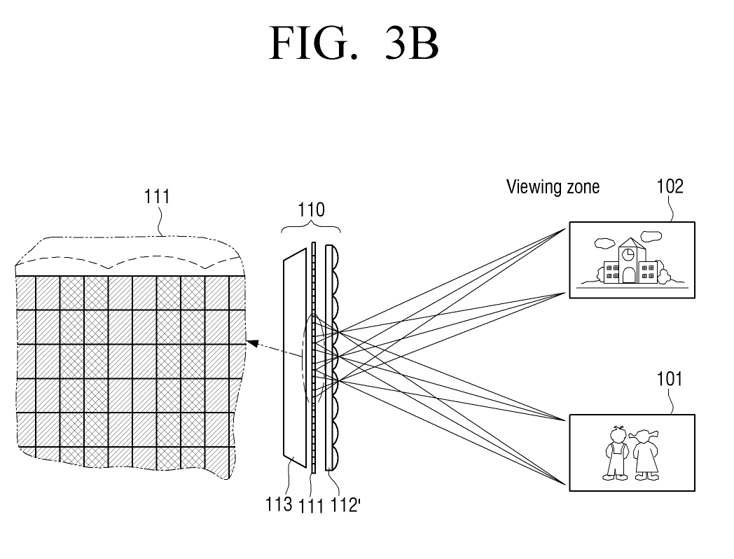

According to another example, the view field divider 112 may be implemented as the lenticular lens which includes a plurality of lens areas. Accordingly, the lenticular lens may refract the image displayed on the display panel 111 through a plurality of lens areas. Each lens area may be formed in a size corresponding to at least one pixel, and disperse the light which penetrates each pixel differently into the first area 101 and the second area 102. The configuration that the display panel 111 displays a plurality of contents at the same time and that the view field divider 112 divides the view field into a plurality of areas will be described in detail with reference to FIGS. 3A and 3B.

The display apparatus 100 may include the sensor 120 which senses a user. Here, the sensor 120 may be implemented as a proximity sensor, a camera which may sense the viewing position of a user, and the like.

If the sensor 120 senses the user, the display apparatus 100 may determine the area which is viewable by a sensed user, and provide a content to the determined area. Specifically, if the view field is divided into the first area 101 and the second area 102 through the view field divider 112 and a user is sensed in the first direction, the display apparatus 100 may provide a content to the first area 101, which is viewable by the user at the first direction. In this case, the display apparatus 100 may not provide a content to the second area 102. If a user is additionally sensed in the second direction, the display apparatus 100 may provide contents to both of the first area 101 and the second area 102. In addition, the display apparatus 100 may provide different contents to the first area 101 and the second area 102 based on at least one of the privacy level of the content and the type of the content.

In addition, the sensor 120 may sense, from which direction the touch of a user with regard to the display apparatus 100 has been input, between the first direction and the second direction. For example, if one of the sensors disposed at the left and right sides based on the display apparatus 100 is covered by a touch input of a user, the sensor 120 may sense the touch direction. In this case, the display apparatus 100 may control the content provided in the area which is viewable by the user at the sensed touch direction to execute the function corresponding to the touch input of the user. For example, if the touch direction sensed by the sensor 120 is the first direction, the display apparatus 100 may control the content provided to the first area 101 viewable by the user at the first direction to execute the function corresponding to the touch command. However, it is not limited thereto, and the sensor 120 may be implemented as a camera and the like and sense the touch direction of the user, and the display apparatus 100 may be connected to a vehicle and receive the sensed result from the sensor disposed in the vehicle as described below.

The communication interface 130 may communicate with an external terminal apparatus. Here, the communication interface 130 may receive an external input signal from at least one of external terminals by using at least one of wired/wireless manners. Accordingly, the display apparatus 100 may perform a communication with an external terminal apparatus, and display a content executed in the external terminal apparatus. Here, the display apparatus 100 may display a content on at least one viewing area between the first area 101 and the second area 102 based on the privacy level of a content executed in the external terminal apparatus. Here, the content may include an application executed in the external terminal apparatus.

The processor 140 controls overall operations of the display apparatus 100.

First, the processor 140 may determine the area, which is viewable by a user, based on the sensed result of the sensor 120. In this case, the processor 140 may control the view field divider 112 so that a content is provided to the determined area. For example, if the sensor 120 senses the user at the first direction based on the display apparatus 100, the processor 140 may determine the first area 101 corresponding to the first direction as the area viewable by the user, and provide a content to the first area 101. In this case, the display apparatus 100 may not provide a content to the second area 102 corresponding to the second direction in which it is determined that a user does not exist.

In addition, if it is sensed that users are positioned at both of the first direction and the second direction, the processor 140 may provide a personal content to one of the first area 101 and the second area 102 based on the privacy level of a plurality of contents displayed on the display 110. For example, if the sensor 120 senses users in both of the right and left directions from the display apparatus 100, the processor 140 may provide contents to the first area 101 and the second area 102, and a personal content may be provided to one of the first area 101 and the second area 102. Accordingly, the personal content may be provided to one area and different content may be provided to the user at the remaining area. Here, the content provided to the user at the remaining area may be a public content or another personal content.

In addition, if the processor 140 provides the personal content to one of the first area 101 and the second area 102, the area to where the content would be provided may be determined based on the predetermined standard. Here, the predetermined standard may be at least one of the area in which an input of a user is sensed, the area in which a user of an external terminal is located, and a predetermined area for each content. Accordingly, if the processor 140 determines the area in which a content would be provided based on the predetermined standard, a personal content may be provided to the determined area between the first area 101 and the second area 102. For example, if it is determined that the user command for displaying a personal content is input in the first area 101 which is viewable by a user at the first direction, the personal content may be provided to the first area 101.

In addition, if it is determined that a personal content is received from an external terminal apparatus and the area which is viewable by the user of the corresponding external terminal apparatus is the first area 101, the processor 140 according to an embodiment may provide the personal content to the first area 101. In this case, the content received from the external terminal apparatus may not be provided to the second area 102.

Meanwhile, the processor 140 may provide a public content to both of the first area 101 and the second area 102. In this case, the users located at the first direction and the second direction based on the display apparatus 100 may receive the public content equally.

The processor 140 according to another embodiment may control the display 110 to provide a specific content to one of the first area 101 and the second area 102 based on at least one of a usage of the display apparatus 100 and a type of a content. Here, the type of a content may be divided according to at least one of the frame rate of the content and the attribute of the content. In addition, the attribute of the content may be divided into a video, an image, a document, an audio, an application and the like.

For example, if the display apparatus 100 is implemented as a display apparatus for a vehicle and a content is a video content, the video content may be not appropriate to be provided to a driver's seat. In this case, the processor 140 may cause the video content to be provided only to the area which is viewable by the user at a specific direction (e.g., a passenger's seat). This is to prevent the content which may interrupt driving, such as a broadcast (e.g., DMB), a movie, a drama and the like, from being provided to the driver's seat.

In addition, if different contents are provided to the first area 101 and the second area 102, the processor 140 according to another embodiment may provide different contents with different resolutions. Specifically, the processor 140 may adjust data of the first content and the second content which are provided to different areas and provide the contents with different resolutions. Here, the data of the content may be contrast, luminance, tone, gamma value and the like.

In addition, the processor 140 may set the size of the first display area which displays the first content and the size of the second display area which displays the second content differently in the display panel 111, and make a difference at the resolutions of the first content and the second content. For example, if the processor 140 set the first display area to be relatively bigger than the second display area, the first display area which displays the first content may display the first content using relatively more pixels than the second display area. Accordingly, the first content may be provided to the first area 101 with higher resolution than the second content.

Meanwhile, the view field divider 112 according to another embodiment may be implemented to be able to physically adjust penetrating direction of light. In this case, the processor 140 may adjust at least one of penetrating time (or penetrating frequency) and a direction of light so as to provide the first content and the second content provided to the first area 101 and the second area 102 respectively with different resolutions. For example, if the view field divider 112 is implemented in a form of a plurality of slits which is rotatable physically, the penetrating direction of light may be adjusted.

In addition, the processor 140 may provide a content to the first area 101 and the second area 102 with different resolutions based on a visibility. For example, when the display apparatus 100 is implemented as a display apparatus for a vehicle, the penetration ratio of a visible ray is different according to the area in which users are located (e.g., a driver's seat or a passenger's seat). Accordingly, the processor 140 may provide a content provided to each area with different resolutions based on the visibility with regard to the display apparatus 100 of the users at each direction based on the display apparatus 100. For example, the processor 140 may provide the content with high resolution to the area in which the penetration ratio of the visible ray is high (e.g., a driver's seat and a passenger's seat) so as to maintain the visibility with regard to the display apparatus for a vehicle of users at different directions to be at a certain level.

A storage (not illustrated) may store various data such as an operating system (O/S) software for driving the display apparatus 100, various contents and the like.

According to an embodiment, the storage may include privacy level information for each content. Here, the privacy level information for each content may be at least one of a privacy level of the content according to a user's setting and a unique privacy level of the content. The unique privacy level may be a privacy level set for a content in the content generation stage. However, it is not limited thereto, and the display apparatus 100 may receive the privacy level information from an external server through the communication interface 130.

Meanwhile, if the display apparatus 100 is implemented as a display apparatus for a vehicle, the storage may store a map program, a vehicle control menu, another application and the like. Here, the vehicle control menu allows the existing vehicle control function which has been operated by a physical button to be implemented as a user interface which may be displayed. Accordingly, a specific vehicle control function may be executed in response to the user input with regard to the vehicle control menu displayed on the display 110, not to the physical button. For example, an air conditioner included in a vehicle may be controlled by an ‘air conditioner On’ button in the vehicle control menu displayed in the display apparatus 100, not by the physical button.

Hereinafter the detailed configuration of the view field divider 112 will be explained.

FIGS. 3A and 3B are views illustrating the configuration of the display 110 according to an embodiment.

According to FIG. 3A, the view field divider 112 may be implemented as a parallax barrier. The parallax barrier may be disposed at the front side of the display panel 111, and implemented as a transparent slit array including a plurality of barrier areas. Accordingly, the view field spaced apart for a certain distance from the display apparatus may be divided into virtual areas by blocking light through a slit between the barrier areas. Accordingly, the display apparatus 100 may provide a content to at least one area between the first area 101 and the second area 102, and provide different contents to each of the first area 101 and the second area 102.

Specifically, the data signal according to the first content may be supplied to the pixels in the first display area of the display panel 111, and the data signal according to the second content may be supplied to the pixels in the second display area of the display panel 111. In this case, the first content displayed on the first display area of the display panel 111 may be provided to the left area by penetrating the parallax barrier in the left direction. In addition, the second content displayed on the second display area of the display panel 111 may be provided to the right area by penetrating the parallax barrier in the right direction. Accordingly, the first content may be provided to the first area 101 which is viewable by the user at the first direction, and the second content may be provided to the second area 102 which is viewable by the user at the second direction.

For example, if users are sensed at the first direction and the second direction, the display apparatus 100 may provide a data signal according to a personal content to only some display area in the display panel 111. Accordingly, the display apparatus 100 may provide a personal content to one of the first area 101 and the second area 102.

Meanwhile, the display apparatus 100 displays the data signal according to a public content to the first display area and the second display area without distinction. That is, a frame of the public content may be provided to all pixels included in the display panel 111. Accordingly, the display apparatus 100 may provide the same content to the first area 101 and the second area 102. In this case, the contents which have different resolutions may be provided according to whether the function of the view field divider 112 is turned on/off. For example, if the function of a lenticular lens is in an off state, the content of which resolution is the same as the resolution of a display screen is provided to a viewer, but if the function of the lenticular lens is in an on state, the content of which resolution is lower than the resolution of the display screen may be provide to a viewer.

In addition, the view field divider 112 according to another embodiment may be implemented as a lenticular lens.

According to FIG. 3B, the display panel 111 may include a plurality of pixels which is identified by a plurality of columns. That is, different image views are disposed by intersecting on the pixel column corresponding to each of the first area 101 and the second area 102. For example, the image view corresponding to the first content and the second content may be disposed on the display panel 111 by intersecting.

The backlight unit 113 may provide light to the display panel 111. According to the light provided from the backlight unit 113, each image view formed on the display panel 111 is projected on a lenticular lens array 112′, and the lenticular lens array 112′ disperses the light of each of the projected image view and transmits the light to the first area 101 and the second area 102. That is, the dispersed image lights provide contents to the first area 101 and the second area 102. Accordingly, as illustrated in FIG. 3B, the display apparatus 100 may provide different contents to the first area 101 and the second area 102.

Hereinafter various embodiments in which users are sensed at the first direction and the second direction and thus contents are provided to both of the first area 101 and the second area 102 will be described.

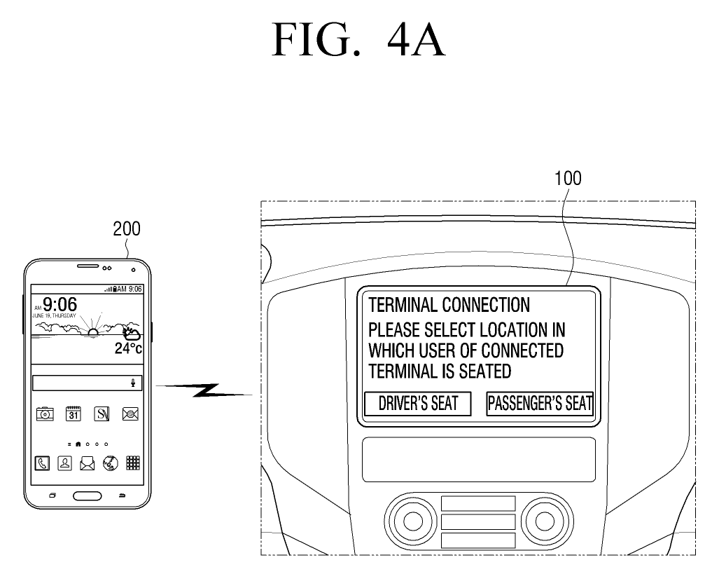

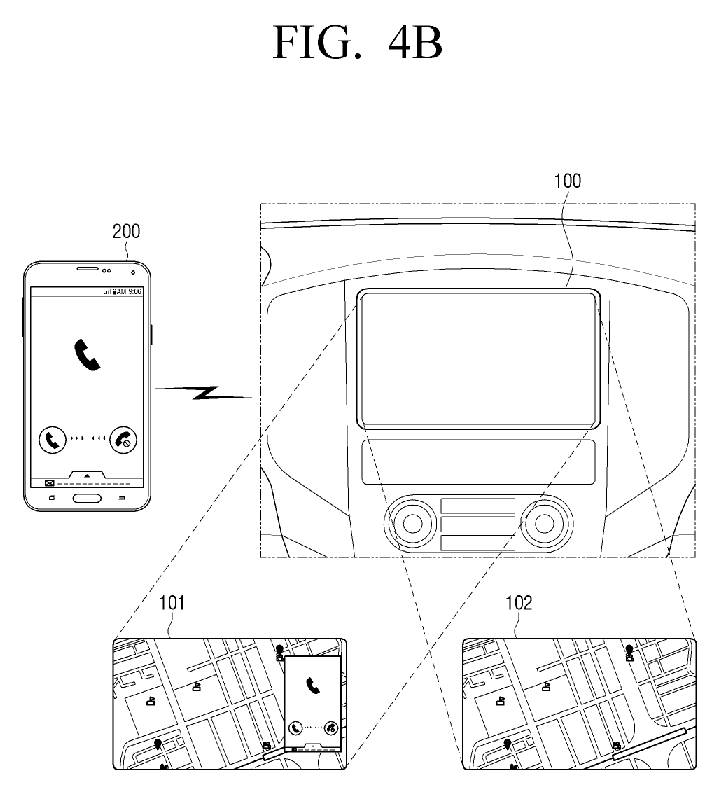

FIGS. 4A and 4B are views illustrating a method for displaying a content based on a privacy level according to an embodiment.

According to FIG. 4A, the display apparatus 100 may determine an area in which a personal content is to be provided based on a predetermined standard. Here, the predetermined standard may be at least one of an area in which a user of the external terminal apparatus 200 is located, a predetermined area for each content, and an area predetermined in the display apparatus 100.

The display apparatus 100 according to an embodiment may display the screen for selecting the area which is viewable by a user of the connected terminal apparatus 200, if the external terminal apparatus 200 is connected to the display apparatus 100. In this case, the display apparatus 100 may provide a personal content to the area according to a user's input. For example, as illustrated in FIG. 4A, if a display apparatus for a vehicle is connected to the external terminal apparatus 200, the screen for selecting the area which is viewable by the user of the external terminal apparatus 200 is displayed.

Meanwhile, as illustrated, the display apparatus 100 may be implemented as various types of apparatuses such as a TV, a monitor, a PC, a tablet PC, a display apparatus for a vehicle, a navigation and the like, but hereinafter the display apparatus 100 will be postulated as a display apparatus for a vehicle for convenience in explanation.

The display apparatus 100 according to an embodiment may provide a personal content to an area according to a user's input. For example, if the user of a connected external terminal apparatus 200 is located at a driver's seat, the display apparatus 100 may provide a personal content only to the area which is viewable by the user at the driver's seat. In this case, the users at the driver's seat and the passenger's seat may be provided different contents.

Meanwhile, the display apparatus 100 according to another embodiment may determine the predetermined standard based on information the external terminal apparatus 200. For example, if it is determined that the external terminal apparatus 200 connected to the display apparatus of a vehicle is the external terminal apparatus 200 which has been connected to the display apparatus of the vehicle for predetermined times or more, or that the external terminal apparatus 200 of the owner of the vehicle, the personal content may be provided only to the driver's seat. In this case, the display apparatus for a vehicle may not display the screen for selecting the area which is viewable by the user of the external terminal apparatus 200.

As illustrated in FIG. 4B, the display apparatus for a vehicle may provide a public content to both of the first area 101 and the second area 102. For example, a map application of which privacy level is lower than the predetermined level may be provided to the first area 101 (e.g., the area viewable by the user at a driver's seat) and the second area 102 (e.g., the area viewable by the user at a passenger's seat) at the same time.

Meanwhile, as illustrated in FIG. 4B, the case in which a display apparatus for a vehicle displays a personal content received from an external terminal apparatus 200 may be assumed. In this case, the display apparatus for a vehicle may provide the personal content to one of the first area 101 and the second area 102. Specifically, the display apparatus 100 may determine the privacy level of the content received from the external terminal apparatus 200 and if the content is determined as a personal content, the display apparatus 100 may provide the content to a specific area between the first area 101 and the second area 102. For example, as illustrated in FIG. 4B, a personal content (e.g., a phone call or SMS, etc.) may be provided to the area viewable by the user at a ‘driver's seat’. However, it is not limited thereto, and the personal content may be provided to both of the ‘driver's seat’ and ‘passenger's seat’ at the same time according to an additional input of a user.

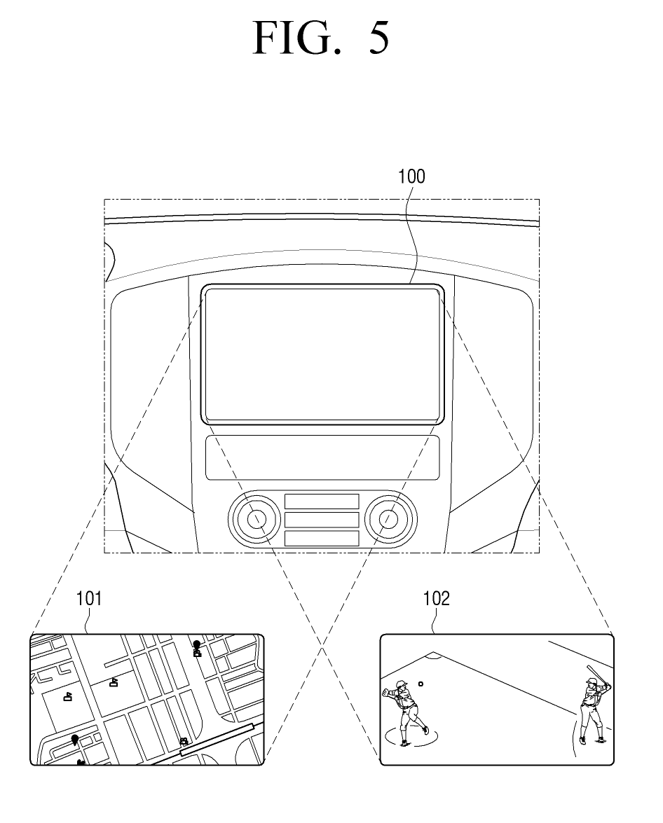

FIG. 5 is a view illustrating a method for displaying a content based on a content type according to an embodiment.

According to FIG. 5, the display apparatus 100 according to another embodiment may provide a content to one of the first area 101 and the second area 102 based on the type of the content.

Specifically, if the display apparatus 100 is implemented as the display apparatus for a vehicle, the content which has a content type inappropriate to be provided to the user at a driver's seat may be provided only to the area viewable by the user at a passenger's seat. For example, as illustrated in FIG. 5, the display apparatus for a vehicle may display a map application to the driver's seat, and provide the content such as a broadcast (e.g., DMB), a movie, a drama and the like only to the passenger's seat. This is to prevent the content which may interrupt driving, such as a broadcast (e.g., DMB), a movie, a drama and the like, from being provided to the driver's seat.

Hereinafter the method for controlling the display apparatus will be described in detail based on a touch direction.

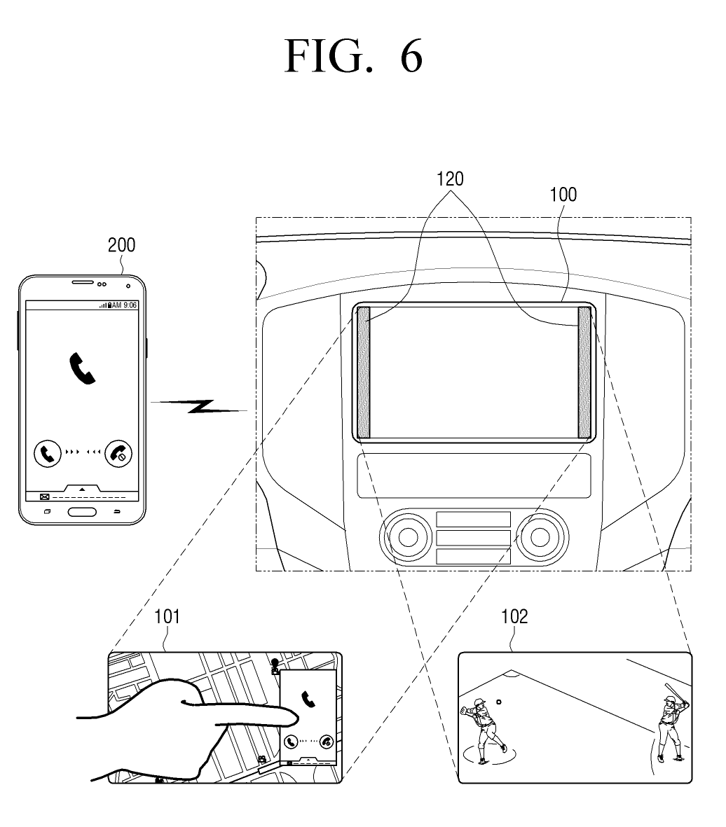

FIG. 6 is a view illustrating a controlling method of a display apparatus based on a touch direction according to an embodiment.

As illustrated in FIG. 6, the sensor 120 included in the display apparatus 100 may sense a touch direction. Specifically, at the same time when a touch command of a user on the display apparatus 100 is input, the sensor 120 may sense the direction from which the touch command has been input.

For example, the sensor 120 may be located at the left and the right positions based on the display apparatus 100. In this case, if one of the sensors 120 disposed at the left and the right sides is blocked according to a user's touch input, the sensor 120 may sense the direction from which the touch command is input based on this, and determine the area which is viewable by the user who has input the touch, based on the sensed direction. For example, as illustrated in FIG. 6, if the sensor disposed at the left side based on the display apparatus for a vehicle is blocked according to a touch of a user, the display apparatus for a vehicle may determine the touch direction as a left direction (e.g., driver's seat direction), and determine that the user at the left side has input the sensed touch command.

In addition, if the touch command is input, the display apparatus 100 may control the content provided to the area viewable by the user at the touched location to execute the function corresponding to the touch command. For example, if a touch command with regard to the display apparatus 100 is input, and it is sensed that a touch command has been input from the first direction, the display apparatus 100 may control the content provided to the first area 101 viewable by the user at the first direction to execute the function corresponding to the touch command.

As illustrated in FIG. 6, if a touch command is input from the user at the driver's direction, the processor 140 may control the content provided to the area corresponding to a driver's direction to execute the function corresponding to the touch command. In this case, a map application and a telephone application provided to the area which is viewable by the user at the driver's seat may not be controlled by a touch command of the user at the passenger's seat.

Meanwhile, the display apparatus 100 does not necessarily include a plurality of sensors 120, and may sense the direction in which the user is located and a touch direction by using at least one sensor 120. For example, the sensor 120 may be disposed at the bottom of the display apparatus 100 as a single sensor and sense the touch direction. In addition, the sensor 120 may be implemented as a camera and sense an area which is viewable by the user who has input a touch command or sense a touch direction.

Meanwhile, if the display apparatus 100 is implemented as a display apparatus for a vehicle according to an embodiment, the display apparatus for a vehicle may display a vehicle control menu. In this case, the display apparatus 100 may control the vehicle to execute a vehicle control function with regard to the area corresponding to a touch direction.

Specifically, if the display apparatus for a vehicle provides the vehicle control menu and a touch command on the display apparatus 100 is input, the display apparatus 100 may sense the touch direction with regard to the display panel between the first direction and the second direction. For example, if the user at the first direction touches a display panel, the display apparatus 100 may sense that the touch command has been input in the first direction. In this case, the display apparatus 100 may control the vehicle to execute the vehicle control function according to the touch command on the first area corresponding to the first direction. For example, if a hot-wire seat temperature adjusting menu is displayed and a touch command is input from the first direction, the temperature of the hot-wire seat located at the first direction may be adjusted. Accordingly, if the first direction is a driver's direction, the temperature of the hot-wire seat of the driver's seat corresponding to the driver's direction is adjusted according to the touch command, and the temperature of the hot-wire seat of a passenger's seat corresponding to a passenger's direction which is the second direction is not changed. Meanwhile, the above described vehicle control menu may be the menu which displays various functions which may be controlled in the vehicle in which the display apparatus for a vehicle is disposed.

Hereinafter various embodiments in which the display apparatus 100 is implemented as the display apparatus for a vehicle and connected to a vehicle will be described.

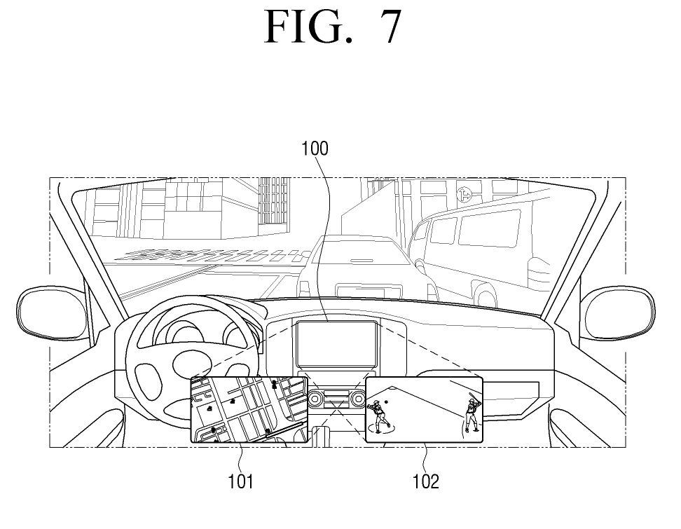

FIG. 7 is a view illustrating an embodiment in which a display apparatus is implemented as a display apparatus for a vehicle according to an embodiment.

According to FIG. 7, the display apparatus 100 may be connected to a vehicle in the implementation. As described above, the display apparatus 100 may determine whether a user is located at a driver's seat and a passenger's seat, and provide a content to the determined location. For example, if a user is sensed at a driver's seat and a user is not sensed at a passenger's seat, the display apparatus 100 may provide a content to the area which is viewable by the user at the driver's seat.

In addition, if a user is sensed in the driver's seat and the passenger's seat, the display apparatus 100 according to an embodiment may display different contents at the same time based on the predetermined standard with regard to a content. In this case, the user at the driver's seat and the user at the passenger's seat may receive different contents.

As illustrated in FIG. 7, if the display apparatus 100 displays a vehicle control menu, the display apparatus 100 may transmit the information with regard to the touch direction and a touch command to a vehicle, and may control the vehicle to execute the function corresponding thereto.

Specifically, if it is determined that the touch command of a user on the display apparatus 100 has been input from the driver's direction or the passenger's direction, and the function corresponding to the touch command is a vehicle control function, the display apparatus 100 may transmit the information on the direction from which the touch command has been input and on the touch command to the vehicle. In this case, the vehicle may perform the function corresponding thereto. For example, if a touch command is input from the driver's direction, the display apparatus 100 may transmit the information regarding the touch command to a vehicle, and the vehicle may control the temperature of driver's seat/ventilation temperature, volume near the driver's seat and the like in response to the received information.

The display apparatus 100 according to another embodiment may not include a sensor and a communication interface. Specifically, the display apparatus 100 may be connected to a vehicle, and sense or determine the location of a user based on the sensor disposed at the vehicle, and perform a communication with the external terminal apparatus 200 based on the communication interface disposed at the vehicle. For example, the display apparatus 100 may receive the information on whether a user got on a vehicle from the sensor included in the seat of the vehicle, and based on this, provide a content to at least one area between the first area 101 and the second area 102.

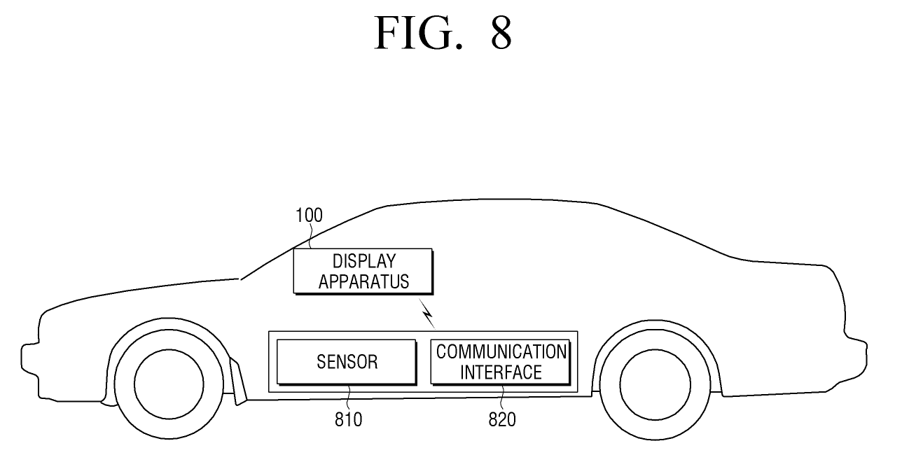

FIG. 8 is a view illustrating an embodiment in which a display apparatus is connected to a vehicle.

As illustrated in FIG. 8, the display apparatus 100 according to an embodiment may not include the sensor 120 for sensing a user and the communication interface for communicating with the external terminal apparatus 200. In this case, the display apparatus 100 may be connected to a vehicle, determine the area viewable by a sensed user based on the information received from the vehicle, and transmit data to/receive data from the external terminal apparatus 200.

For example, the display apparatus 100 may receive a sensed result from the sensor 810 included in the seat of a vehicle, and determine the area which is viewable by the user who took the vehicle based on the received result. In this case, the display apparatus 100 may provide a content to the determined area.

As described above, the display apparatus 100 may be implemented as a part of the configuration of a vehicle. In addition, the display apparatus 100 may be connected to a vehicle and realize various embodiments by using the sensor or the communication interface included in the vehicle.

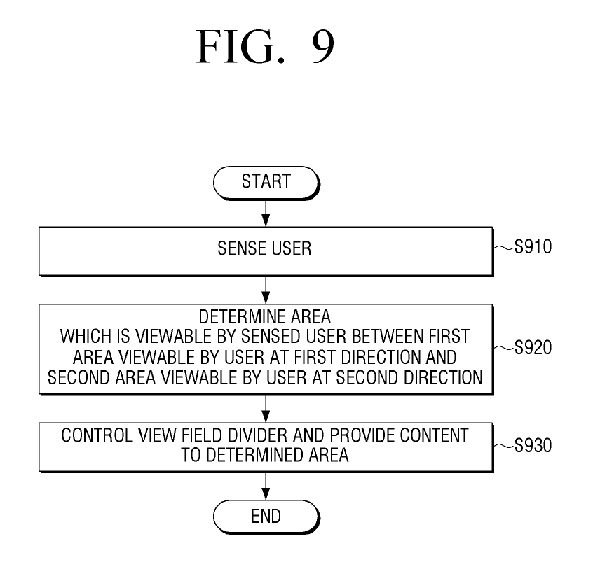

FIG. 9 is a flow chart illustrating a method for controlling a display apparatus according to an embodiment.

According to FIG. 9, the display apparatus, which includes a display panel and a view field divider which is disposed at the front side of the display panel and divides a view field in which a content is provided, senses a user in S910.

In S920, the area which is viewable by a sensed user in S910, between the first area 101 viewable by the user at the first direction from the display apparatus and the second area 102 viewable by the user at the second direction from the display apparatus.

Accordingly, a content is provided to the determined area by controlling the view field divider in S930.

In S930, if it is determined that the first user and the second user are located at the first direction and the second direction respectively based on the sensed result, different contents or the same content may be provided to the first and the second areas based on a predetermined standard.

Here, the predetermined standard is a privacy level for each content, and in S930, the content of which privacy level is equal to or higher than the predetermined level may be provided to one of the first area and the second area, and the content of which privacy level is lower than the predetermined level may be provided to both of the first area and the second area.

In addition, in S930, if the content of which privacy level is equal to or higher than the predetermined level is provided to one of the first area and the second area, the content of which privacy level is lower than the predetermined level may be provided to the remaining area.

Meanwhile, in S930, if different contents are provided to the first and the second areas, the different contents may be provided in different resolutions.

In addition, the controlling method may further include communicating with at least one external terminal apparatus, and the content may include an application executed in the external terminal apparatus.

Here, in S930, if the privacy level of the application is equal to or higher than the predetermined level, the application may be provided to the area which is viewable by the user of the external terminal apparatus between the first area and the second area.

Meanwhile, the display apparatus may be implemented as a display apparatus for a vehicle, and the first direction may be a driver's direction based on the display apparatus for a vehicle, and the second direction may be a passenger's direction based on the display apparatus for a vehicle.

In addition, in S910, the touch direction with regard to a display panel is detected, and if a touch command is input on the display panel, the content, provided in the area corresponding to the touch direction of the touch command between the first area and the second area, is controlled to execute the function corresponding to the touch command.

In addition, the display apparatus according to an embodiment may be implemented as a display apparatus for a vehicle, and in S910, the touch direction with regard to the display panel is sensed, and the controlling method may include, if a touch command with regard to a vehicle control menu provided on the display panel is input, controlling to execute a vehicle control function with regard to the area corresponding to the touch direction of the touch command between the first area and the second area.

The methods according to the above-described various embodiments may be realized in a form of software or applications that may be installed in the existing display apparatus. Meanwhile, the methods according to various embodiments as described above may be implemented by upgrading software for the existing display apparatus.

In addition, various embodiments as described above may be performed through an embedded server provided in the display apparatus or a content output device, or an external server of the display apparatus.

Further, a non-transitory computer readable medium in which a program sequentially performing the control method according to the embodiment is stored may be provided.

For example, a non-transitory computer readable medium which stores a program which senses a user, determines the area which is viewable by the sensed user between the first area 101 viewable by the user at the first direction based on the display apparatus and the second area 102 viewable by the user at the second direction based on the display apparatus, and provides a content to the determined area by controlling a view field divider, may be provided.

The non-transitory computer readable medium is not a medium that stores data for a short moment such as a register, a cash and a memory and the like, but a medium that stores data semi-permanently and which is readable by an apparatus. In detail, the above-described various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

Although various embodiments of the present disclosure have been illustrated and described hereinabove, the present disclosure is not limited to the above-mentioned embodiments, but may be variously modified by those skilled in the art to which the present disclosure pertains without departing from the scope and spirit of the disclosure as set forth in the accompanying claims. These modifications should also be understood to fall within the scope of the present disclosure.

What is claimed is:

1. A display apparatus comprising:
a display panel configured to display a content;
a view field divider provided at a front side of the display panel, wherein the view field divider divides a view field in which the content is provided;
a sensor configured to sense a location of a user; and
a processor configured to identify an area between a first area viewable at a first direction from the display apparatus and a second area viewable at a second direction from the display apparatus based on the sensed location of the user, and control the view field divider to provide the content to the identified area.

2. The display apparatus as claimed in claim 1, wherein
the sensor is further configured to sense a first location of a first user and a second location of a second user; and
the processor is further configured to:
identify, based on the sensed first and second locations of the first and second users, respectively, that the first user is positioned at the first direction and the second user is positioned the second direction; and
provide different contents or the same content to the first area and the second area based on a predetermined standard.

3. The display apparatus as claimed in claim 2, wherein the predetermined standard is a privacy level for each content, and
wherein the processor is further configured to provide a first content having a first privacy level equal to or higher than a predetermined level to one of the first area and the second area, and provide a second content having a second privacy level lower than the predetermined level to both of the first area and the second area.

4. The display apparatus as claimed in claim 3, wherein the processor, in response to providing the first content to the one of the first area and the second area, is further configured to provide the second content to a remaining one of the first area and the second area.

5. The display apparatus as claimed in claim 2, wherein the processor is further configured to provide the different contents with different resolutions.

6. The display apparatus as claimed in claim 2, further comprising:
a communication interface configured to communicate with at least one external terminal apparatus,
wherein the content includes an application executed in the external terminal apparatus.

7. The display apparatus as claimed in claim 6, wherein the processor is further configured to provide, in response to a privacy level of the application being equal to or higher than a predetermined level, the application to an area which is viewable by a user of the external terminal apparatus between the first area and the second area.

8. The display apparatus as claimed in claim 1, wherein the display apparatus is implemented as a display apparatus for a vehicle,
wherein the first direction is a driver direction from the display apparatus for a vehicle, and
wherein the second direction is a passenger seat direction from the display apparatus for a vehicle.

9. The display apparatus as claimed in claim 1, wherein the sensor is further configured to sense a touch direction with regard to the display panel, and
wherein the processor is further configured to execute, in response to a touch command being input on the display panel, a function corresponding to the touch command on a content provided to an area corresponding to a touch direction of the touch command between the first area and the second area.

10. The display apparatus as claimed in claim 1, wherein the display apparatus is implemented as a display apparatus for a vehicle,
wherein the sensor is further configured to sense a touch direction with regard to the display panel, and
wherein the processor is further configured to execute, in response to a touch command with regard to a vehicle control menu provided on the display panel being input, a vehicle control function with regard to an area corresponding to a touch direction of the touch command between the first area and the second area.

11. A controlling method of a display apparatus which comprises a display panel and a view field divider provided at a front side of the display panel and configured to divide a view field in which a content is provided, the controlling method comprising:
sensing a location of a user;
identifying, based on the sensed location of the user, an area between a first area viewable at a first direction from the display apparatus and a second area viewable at a second direction from the display apparatus, and
providing the content to the identified area by controlling the view field divider.

12. The controlling method as claimed in claim 11, further comprising:
sensing a first location of a first user and a second location of a second user; and
identifying, based on the sensed first and second locations of the first and second users, respectively, that the first user is positioned at the first direction and the second user is positioned the second direction; and
providing different contents or the same content to the first area and the second area based on a predetermined standard.

13. The controlling method as claimed in claim 12, wherein the predetermined standard is a privacy level for each content, and
wherein the providing the content further comprises:
providing a first content having a first privacy level equal to or higher than a predetermined level to one of the first area and the second area, and
providing a second content having a second privacy level lower than the predetermined level to both of the first area and the second area.

14. The controlling method as claimed in claim 13, wherein the providing the content further comprises, in response to providing the first content to the one of the first area and the second area, providing the second content to a remaining area one of the first area and the second area.

15. The controlling method as claimed in claim 12, wherein the providing the content further comprises, providing the different contents with different resolutions.

16. The controlling method as claimed in claim 12, further comprises communicating with at least one external terminal apparatus,
wherein the content includes an application executed in the external terminal apparatus.

17. The controlling method as claimed in claim 16, wherein the providing the content further comprises, in response to a privacy level of the application being equal to or higher than a predetermined level, providing the application to an area which is viewable by a user of the external terminal apparatus between the first area and the second area.

18. The controlling method as claimed in claim 11, wherein the display apparatus is implemented as a display apparatus for a vehicle,
wherein the first direction is a driver direction from the display apparatus for a vehicle, and
wherein the second direction is a passenger seat direction from the display apparatus for a vehicle.

19. The controlling method as claimed in claim 11, wherein the sensing further comprises sensing a touch direction with regard to the display panel, and
wherein the controlling method further comprises, in response to a touch command being input on the display panel, controlling to execute a function corresponding to the touch command on a content provided to an area corresponding to a touch direction of the touch command between the first area and the second area.

20. The controlling method as claimed in claim 11, wherein the display apparatus is implemented as a display apparatus for a vehicle,
wherein the sensing comprises sensing a touch direction with regard to the display panel, and
wherein the controlling method further comprises, in response to a touch command with regard to a vehicle control menu provided on the display panel being input, controlling to execute a vehicle control function with regard to an area corresponding to a touch direction of the touch command between the first area and the second area.
